(19) United States
(12) Patent Application Publication
(10) Pub. No.: US 2021/0268921 A1
(43) Pub. Date: Sep. 2, 2021

(54) ELECTRICAL DRIVE SYSTEM FOR AN ELECTRICALLY OPERATED VEHICLE, AND METHOD FOR INDUCTIVELY CHARGING AN ENERGY STORAGE DEVICE OF AN ELECTRICALLY OPERATED VEHICLE

(71) Applicant: Robert Bosch GmbH, Stuttgart (DE)

(72) Inventor: Klaus Ries-Mueller, Bad Rappenau (DE)

(21) Appl. No.: 16/967,623

(22) PCT Filed: Jan. 30, 2019
(86) PCT No.: PCT/EP2019/052203

§ 371 Date: Aug. 5, 2020

(30) Foreign Application Priority Data
Feb. 6, 2018 (DE) 10 2018 201 821.9

(51) Int. Cl. B60L 53/124; B60L 53/24; B60L 53/126

(52) U.S. Cl. CPC B60L 53/124; H02J 50/10; B60L 53/126; B60L 53/24

(57) ABSTRACT

The present invention provides an electrical drive system (1) for an electrically operated vehicle (F1), comprising an electrical machine (EM) by means of which a traction drive of the electrically operated vehicle (F1) can be driven; an energy storage device (B) by means of which the electrical machine (EM) can be operated; an inverter device (INV) by means of which the energy storage device (B) is connected to the electrical machine (EM); a first inductance (L1) by means of which the energy storage device (B) can be inductively charged, wherein the electrical machine (EM) comprises a housing (3) and the first inductance (L1) is integrated into the housing (3) or is arranged directly on the housing (3); and a converter device (W), which is connected to the first inductance (L1) and to the energy storage device (B), for charging the energy storage device (B).

### BACKGROUND

The present invention relates to an electric drive system for an electrically operated vehicle and a method for inductively charging an energy storage device of an electrically operated vehicle.

Electrically operated vehicles having a traction drive, wherein the electric motor is driven by a battery, are mostly connected overnight to the 230 V power supply system so as to charge the battery. Usually, the charging procedure is performed by means of a 3 kW charging device. In order to charge said battery, it is necessary in the case of a conductive charging procedure to use a plug connection on the electrically operated vehicle or to connect up to said vehicle. In the event that the energy is transmitted by means of induction (wireless charging) it is possible to forego the plug connection, and to start the charging procedure in a simpler manner, in that it is only necessary to position an induction coil (secondary coil) precisely over a changing magnetic field (primary coil) that is intended for the charging procedure. In order to perform the inductive charging procedure, two planar metal plates, each having one coil, are usually moved as close as possible to one another, wherein the battery is charged by means of induction via the coil on the electrically operated vehicle. In order to be able to combine the necessary electronic components (electronic power system), the electric motor, the drive axle (transmission etc.) and also further components into space-saving and easier-to-handle assemblies, the trend of integrating the components is becoming increasingly more important. It is possible with a greater degree of integration to reduce the number of cables and plugs in the drive system.

DE 10 2012 014 185 A1 describes an energy transmission apparatus for a passenger car having an inductive energy transmitting module, wherein it is possible to arrange an energy transmitting apparatus on the front end, rear end or in the middle section of the vehicle.

### SUMMARY

The present invention provides an electric drive system for an electrically operated vehicle and a method for inductively charging an energy storage device of an electrically operated vehicle.

The idea that forms the basis of the present invention is to propose an electric drive system for an electrical operated vehicle, wherein both a vehicle-side inductance for inductively charging a battery in the vehicle and advantageously also further electronic components may be arranged directly on the electric machine or integrated with one another in an electric axle in order to realize an integrated construction and advantageously to be able to reduce the required number of cable connections and plug connections.

In accordance with the invention, the electric drive system comprises for an electrically operated vehicle:

an electric machine, by means of which it is possible to drive a traction drive of the electrically operated vehicle,
an energy storage device, by means of which the electric machine may be operated, an inverter facility, by way of which the energy storage device is connected to the electric machine,
a first inductance, by way of which the energy storage device may be inductively charged, wherein the electric machine comprises a housing and the first inductance is integrated into the housing or is arranged on the housing, and
a converter facility which is connected to the first inductance and to the energy storage facility so as to charge the energy storage device.

The electrically operated vehicle may be advantageously a fully electrically operated vehicle or an in-part electrically operated vehicle, possibly a hybrid vehicle (plug-in hybrid), which comprises an inductively chargeable energy storage device, advantageously a traction battery. The traction battery advantageously comprises further components, such as a transmission, gear-reduction facilities or gear-increasing facilities, sensor facilities that are required for the drive, the motor and the steering, and also controllers, on-board electrical systems and the like. Advantageously, the said components may be to the most part or as a whole integrated into a drive axle of the electrically operated vehicle, possibly in an electric axle, as a result of which a space-saving and compact construction is advantageously realized.

The energy storage device advantageously comprises a battery, possibly a high voltage battery having a voltage of greater than 60 V, by way of example 400 V or even higher (for example 800 V).

The first inductance advantageously comprises a coil having at least one winding on a core or on a plate which may be positioned so as to inductively charge the energy storage device in a changing magnetic field of a primary coil, advantageous at a charging station. The first inductance advantageously comprises the secondary coil so as to inductively charge said energy storage device. The primary coil also comprises a plate that during the charging procedure is arranged in a ground region below the electrically operated vehicle.

It is possible by way of the inverter facility to advantageously convey to the electric machine an energy flow from the energy storage device so as to operate the electric machine, wherein the inverter facility advantageously comprises switch facilities that may be switched by means of a modulation signal by way of example from a control facility. The inverter facility advantageously provides three phases for controlling the electric machine in the integrated state as a so-called “attached inverter” or “eAxle+”).

The inverter facility and the converter facility may advantageously each comprise a dedicated housing or may be integrated in a housing of another component, as a result of which it is advantageously possible to save space and reduce the number of connecting elements required (cables, plugs). In order to configure the electric drive system in a space-saving manner in the electrically operated vehicle, the first inductance is configured together with the electric machine in such a manner that the first inductance is installed in the housing of the electric machine, in particular integrated, or is arranged as an independent component above, below or on the side of the housing of the electric machine (screwed, plugged on, attached).

The converter facility, advantageously a direct converter facility comprising an AC-DC convertor, is configured so as to convert an alternating signal (current, voltage) from the first inductance into a direct signal (current, voltage) in order thus to be able to charge the energy storage device. The converter facility may be advantageously adapted to a voltage level (60 V, 400 V or higher) required by the energy storage device. The converter facility may advantageously also function in the opposite direction and possibly convert a direct current (direct voltage) from the energy storage device into an alternating current (alternating voltage) and by way of the first inductance transfer energy by way of example back into the power supply system. As a consequence, it advantageously also possible that the energy storage device is used as an intermediate storage facility for current from an energy provider, wherein in the case of excess current in its power supply system said intermediate storage facility is able to advantageously store the current in the energy storage device (possibly overnight if the vehicle is not being operated but the battery is connected to the power supply system for charging) and/or when current is required in the power supply system to use the energy storage device as an energy source (in the event that the vehicle is not being driven and is currently connected to the power supply system, wherein it is also possible for the vehicle owner to sell energy).

The first inductance may advantageously also be arranged directly on the housing of the electric machine.

In accordance with one preferred embodiment of the electric drive system, the inverter facility is arranged in an electronics housing that is arranged directly on the electric machine.

The electronics housing may be advantageously plugged onto the housing of the electric machine, as a result of which it is advantageously possible to completely forego cables and supply lines between the two housings. The two housings may advantageously only be connected by means of a plug connection, advantageously in an electrical and mechanical manner.

In accordance with one preferred embodiment of the electric drive system, the electronics housing comprises the converter facility.

For space-saving reasons, the converter facility may be advantageously arranged together with the inverter facility in the electronics housing, in a so-called “shared-accommodation arrangement”. In so doing, the electronic components of the two facilities are each arranged on an identical printed circuit board or on printed circuit boards that are separated from one another. The electronics housing advantageously comprises only one outer connection for the energy storage device and an outer connection for the first inductance, wherein advantageously each outer connection comprises in each case a plug facility, advantageously respectively precisely one plug facility, which is advantageously connected inside the electronics housing to the inverter facility and/or to the converter facility. Also with respect to the electric machine, the connection to the electronics housing and to the housing of the electric machine may be realized by means of a plug connection, or simple supply lines to only one connection on the respective housing (bus bars). It is advantageously possible by means of such a connecting arrangement (plug connections) to forego multiple separate plugs and supply lines for the inverter facility and the converter facility with respect to the electric machine and the energy storage device and also space and costs may be reduced. The number of required housings may be advantageously reduced and the number of the line and cable arrangements may be advantageously reduced. It is advantageously possible to use synergies between an inductive charging component (converter, coil, housing) and the electrical drive (the electric axle, electric machine, housing, plug).

In accordance with one preferred embodiment of the electric drive system, the electronics housing is arranged directly on the housing.

In accordance with one preferred embodiment of the electric drive system, the electric machine is integrated into an electric drive axle of the electrically operated vehicle.

The electronics housing may be advantageously arranged on an upper face of the housing of the electric machine or laterally on a side, wherein the electronics housing may be advantageously plugged onto the housing. After the electronics housing has been arranged on the housing, these two components act advantageously as a common component in the electric drive system and may be advantageously integrated into a drive axle, advantageously the electric axle. The electric axle may be a mechanical transmission, advantageously an axle that is mechanically connected directly to the electric machine with the result that the electric machine may transmit force to the traction drive on this axle (transmission). The electric axle and an axle, on which are arranged two drive wheels of the electrically operated vehicle or said two drive wheels are connected thereto, are advantageously identical to one another, or are linked by means of a transmission. By virtue of installing the housing in the axle, it is advantageously possible to save space and reduce the number of assembly components in the electrically operated vehicle. The first inductance is advantageously integrated into the electric axle on a lower face (facing the road surface and a primary coil at a charging station).

In accordance with one preferred embodiment of the electric drive system, the electric drive axle is integrated in a front axle and/or in a rear axle of the electrically operated vehicle.

In accordance with one preferred embodiment of the electric drive system, the electronics housing comprises a plug facility by means of which the energy storage device is connected to the inverter facility and to the converter facility.

With respect to the energy storage device, the electronics housing advantageously comprises a, preferably only a single, plug facility which renders it possible to electrically and mechanically connect to a connection of the energy storage device or to a supply line of said energy storage device. The inverter facility and/or the inverter facility is advantageously connected by means of this plug facility to the energy storage device in order to receive an energy flow from the energy storage device or to provide an energy flow to said energy storage device if the electric machine is functioning as a generator and supplying recovered energy to the energy storage device. When the electric machine is functioning in an recovery mode, the inverter facility may advantageously convert an alternating signal of the electric machine into a direct signal so as to charge the energy storage device.

In accordance with one preferred embodiment of the electric drive system, the electric drive system comprises a control facility by means of which it is possible to control the inverter facility and/or the direct converter facility.

The control facility may be arranged separately to the inverter facility and the converter facility or jointly with at least one of these components in a housing, advantageously in the electronics housing. The control facility advantageously controls the inverter facility and/or the converter facility by means of a modulation signal, switching said components on or off and in so doing actuating switch facilities in the inverter facility and/or in the converter facility. The control facility advantageously comprises a microcontroller (on-board electrical system of the machine) and may also be arranged in a space-saving manner in the shared-accommodation arrangement in the electronics housing, as a result of which further plugs and supply lines are not required. Furthermore, the electronics housing may comprise a dedicated current supply as a low voltage supply for the inverter facility and/or for the control facility. Furthermore, it is also possible in the electronics housing to connect the converter facility to the low voltage supply.

In accordance with one preferred embodiment of the electric drive system, the electric drive system comprises a cooling system for the electric machine and/or for the inverter facility (INV) and/or for the converter facility (W).

In accordance with one preferred embodiment of the electric drive system, the electronics housing comprises the cooling system.

The electronics housing advantageously comprises a cooling connection (inlet and outlet) by way of example for cooling water, by means of which it is possible to supply a cooling system in the electronics housing. The cooling system advantageously comprises a cooling circuit, which extends from the inverter facility to the converter facility and back out of the electronics housing, and advantageously also further to the electric machine, and is subsequently directed out of the electric axle. In so doing, the cooling system advantageously comprises a single cooling system (cooling circuit).

In accordance with one preferred embodiment of the electric drive system, the electric drive system comprises a communication facility.

The communication facility is advantageously used for communication outwards (for example in a wireless manner) with a further control facility, a server, a power supply system or other control systems so as to transmit information regarding the cooling water temperature, motor temperature, charge state, etc. The communication facility may be advantageously integrated into the electric axle, by way of example into the electronics housing. By virtue of using the same cooling system, it is advantageously possible to forego multiple cooling systems, multiple routing arrangements of supply lines and connections.

In accordance with one preferred embodiment of the electric drive system, the electric drive system comprises an object detection apparatus by means of which it is possible during the inductive charging procedure to identify a foreign object between the first inductance and a second inductance that is required for the inductive charging procedure.

The object detection apparatus may advantageously comprise a sensor facility in the region of the first inductance or a device for detecting non-typical voltage changes during the inductive charging procedure. The object detection apparatus may be advantageously integrated in the electric axle, possibly as a device for detecting non-typical voltage changes in the electronics housing or may be accommodated in the control facility. For the event that a foreign object, an electrically conductive material or a living being has entered the area between the coils (primary coil and secondary coil) during the inductive charging procedure, the presence of the object is detected and the charging procedure is advantageously terminated before the coils, the energy storage device or the electronic components become damaged.

In accordance with one preferred embodiment of the electric drive system, the first inductance is arranged on a lower face of the electric machine.

Furthermore, the integration of the first inductance into the electric axle, in particular below the electric machine, renders it possible that the first inductance may be particularly close to a second inductance since the spacing between the drive axle and the ground is mainly less than a front section, rear section or middle section of the vehicle.

In accordance with the invention, in the case of the method for inductively charging an energy storage device of an electrically operated vehicle, an electric drive system in accordance with the present invention is provided in a method step S1. In a further method step S2, the electrically operated vehicle is positioned over a second inductance in such a manner that the first inductance is positioned in a magnetic field of the second inductance. In a method step S3, the energy storage device is inductively charged by way of the first inductance.

The features that are described in connection with the electric drive system in accordance with the invention advantageously also apply for the method in accordance with the invention and conversely.

In the charging position, the magnetic field comprises a sufficient field strength for the inductive charging procedure. The positioning may be performed manually or in part automated or fully automated using sensors.

In accordance with one preferred embodiment of the method, in the method step S3, an object detection apparatus detects a foreign object in the magnetic field between the first inductance and the second inductance, and the inductive charging procedure is immediately terminated.

In the event that a foreign object is detected by way of example by means of an algorithm in the control facility, the inductive charging procedure may be terminated, in that said control facility accordingly controls the converter facility.

Further features and advantages of embodiments of the invention are described in the description below with reference to the attached drawings.

### BRIEF DESCRIPTION OF THE DRAWINGS

The present invention is further explained below with reference to the exemplary embodiments illustrated in the schematic figures of the drawing.

In the drawing:

FIG. 1 illustrates a schematic lateral view of an electric drive system for an electrically operated vehicle in accordance with an exemplary embodiment of the present invention;

FIG. 2 illustrates a view of an electric drive axle with an electric drive system;

FIG. 3 illustrates a schematic plan view of an electrically operated vehicle with an electric drive system in accordance with an exemplary embodiment of the present invention;

FIG. 4 illustrates a schematic lateral view of an electrically operated vehicle with an electric drive system in accordance with one embodiment of the present invention; and

FIG. 5 illustrates a block diagram of the method steps in accordance with one exemplary embodiment of the method of the present invention.

In the figures, identical reference numerals identify like or like-functioning elements.

### DETAILED DESCRIPTION

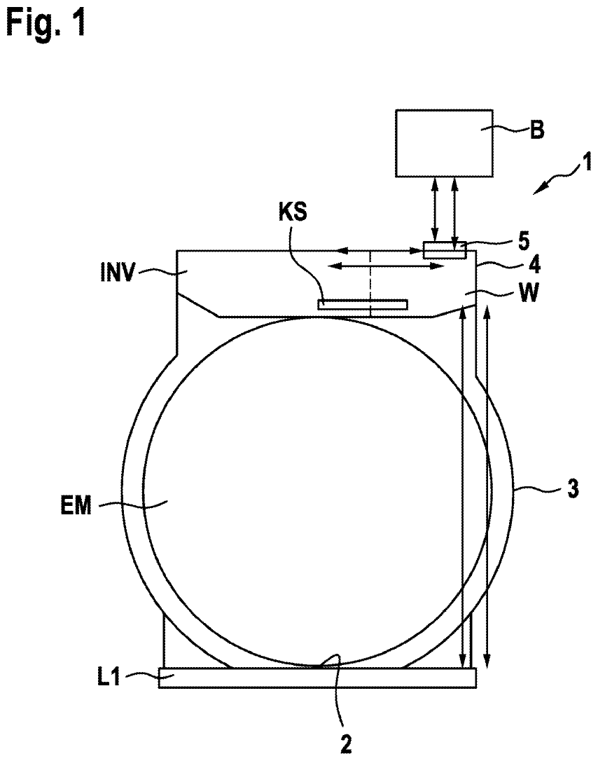

FIG. 1 illustrates a schematic lateral view of an electric drive system for an electrically operated vehicle in accordance with an exemplary embodiment of the present invention.

An electric machine EM is arranged in a housing 3 that may advantageously comprise a cast part. The first inductance L1, advantageously as a plate having a coil, is arranged on a lower face 2 of the electric machine EM with the result that said inductance may face a primary coil for the inductive charging procedure. The first inductance is in this case at least in part integrated into the housing 3, however it may also be arranged on the outside of the housing 3 and connected to the electronics housing 4 by means of electrical conductors, possibly Cu-lines (double arrow, which may be produced in an advantageously cost-effective manner). The electrical conductors advantageously extend within an electrically shielded housing 3 or outside the housing and in this case they themselves comprise an electrical shielding arrangement (insulation). The inverter facility INV and the converter facility W are advantageously arranged jointly in the electronics housing 4 as a shared-accommodation arrangement and are connected by means of internal plug connections or electrical conductors (bus bars) to a plug facility 5. A second converter facility (not illustrated) may also be advantageously accommodated in the electronics housing 4, said converter facility is connected to the inverter facility and when the electric machine is functioning in an recovery mode said converter facility may be used for charging the energy storage device B. The second converter facility may also be arranged separately and outside the electronics housing 4. The plug facility 5 connects the electronics housing 4 to the energy storage device B in an electrical manner by way of the supply lines (bus bars) or plugs (arrow illustration). In the interior of the electronics housing 4, electrical conductors (bus bars) connect the converter facility W and the inverter facility INV to the plug facility 5, wherein in each case advantageously a 2 phase connection is guided to the converter facility W and the inverter facility INV. In the electric drive system 1, the electric machine having the housing 3 and the electronics housing 4 and the first inductance L1 are advantageously combined as a compact electric axle. Furthermore, the electronics housing 4 comprises a cooling system KS that extends advantageously into the region of the inverter facility INV and into the region of the direct converter facility W. It is possible in this manner to reduce the number of plugs, supply lines, cooling system connections and housings.

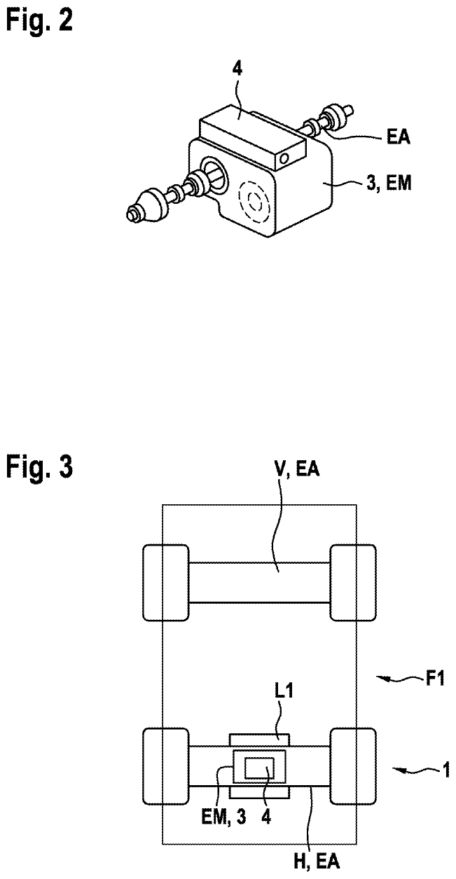

FIG. 2 illustrates a view of an electric drive axle with an electric drive system.

The housing 3 having the electric machine EM integrated therein is connected to a drive axle (transmission), advantageously integrated therein, which is described as an electric axle EA. The electronics housing 4 is advantageously placed directly (with supply lines or plug connections, Cu-conductors or as Cu-rails) on the housing 3 and for space-saving reasons is configured as planar as possible.

FIG. 3 illustrates a schematic plan view of an electrically operated vehicle having an electric drive system in accordance with an exemplary embodiment of the present invention.

The electrically operated vehicle F1 comprises a front axle V and a rear axle H, wherein the electric axle EA may be integrated into the front axle V and/or into the rear axle H. In the plan view of FIG. 3, the electric drive system 1 is visible on the rear axle and comprises a housing 3 having the electric machine EM, wherein the electronics housing 4 is arranged on the housing 3. The first inductance L1 is arranged below the housing 3 and may protrude sideward beyond the axle EA and also the housing 3, however, in a planar manner it may also be smaller or equal in size to the housing 3.

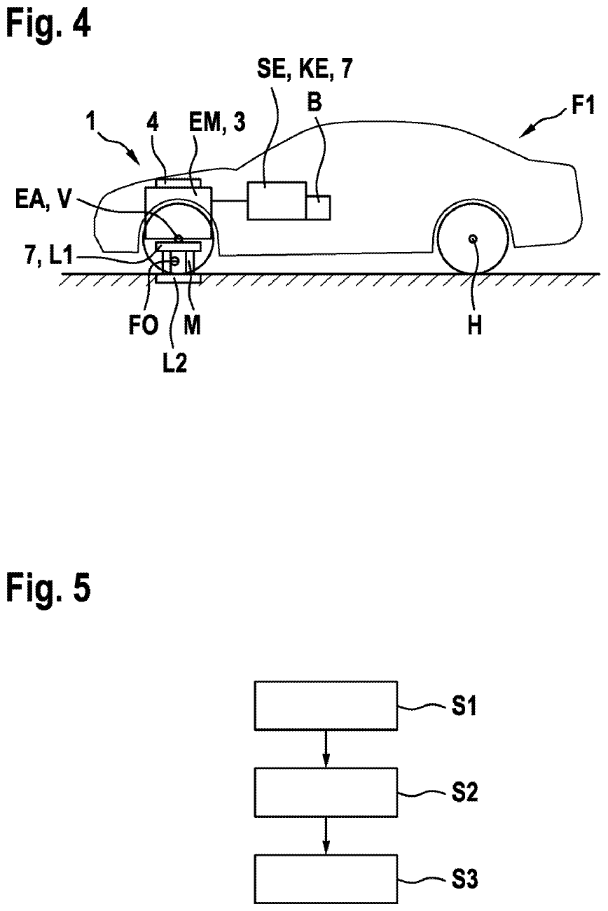

FIG. 4 illustrates a schematic lateral view of an electrically operated vehicle having an electric drive system in accordance with an exemplary embodiment of the present invention.

The electrically operated vehicle F1 comprises an electric drive system 1, which is integrated in the front axle V that represents the electric axle EA. During the inductive charging procedure, the electrically operated vehicle F1 may be positioned over a second inductance L2 so that the first inductance L1 experiences the magnetic field M of the second inductance L2 (also conversely during the supply of energy from the energy storage device B into a power supply system, possibly as a v2grid). An object detection apparatus 7 which may detect a foreign object FO in the magnetic field M is located in the region of the first inductance L1. The housing 3 having the electric machine EM and the electronics housing 4 is integrated into the electric axle EA on the front axle V. A control facility SE and the energy storage device B and the communication facility KE (by way of example also the object detection apparatus having a corresponding algorithm) are by way of example arranged separately from the axle EA in the vehicle F1 and may also comprise a dedicated housing. Alternatively, at least one of them may also be integrated into the electronics housing 4 or into the electric axle EA.

FIG. 5 illustrates a block diagram of the method steps in accordance with an exemplary embodiment of the method of the present invention.

The method steps S1, S2 and S3 are advantageously performed one after the other.

Although the present invention has been fully described above with reference to the preferred embodiments, the invention is not limited thereto but rather may be modified in numerous ways.

1. An electric drive system (1) for an electrically operated vehicle (F1) comprising:
an electric machine (EM) configured to drive a traction drive of the electrically operated vehicle (F1),
an energy storage device (B), by way of which the electric machine (EM) may be operated,
an inverter facility (INV), by way of which the energy storage device (B) is connected to the electric machine (EM),
a first inductance (L1), by way of which the energy storage device (B) may be inductively charged, wherein the electric machine (EM) comprises a housing (3) and the first inductance (L1) is integrated into the housing (3) or is arranged on the housing (3), and
a converter facility (W) which is connected to the first inductance (L1) and to the energy storage facility (B) so as to charge the energy storage device (B).

2. The electric drive system (1) as claimed in claim 1, wherein the inverter facility (INV) is arranged in an electronics housing (4) that is arranged directly on the electric machine (EM).

3. The electric drive system (1) as claimed in claim 2, wherein the electronics housing (4) comprises the converter facility (W).

4. The electric drive system (1) as claimed in claim 2, wherein the electronics housing (4) is arranged directly on the housing (3).

5. The electric drive system (1) as claimed in claim 1, wherein the electric machine (EM) is integrated into an electric drive axle (EA) of the electrically operated vehicle (F1).

6. The electric drive system (1) as claimed in claim 5, wherein the electric drive axle (EA) is integrated in a front axle (V) and/or in a rear axle (H) of the electrically operated vehicle (F1).

7. The electric drive system (1) as claimed in claim 3, wherein the electronics housing (4) comprises a plug facility (5) by means of which the energy storage device (B) is connected to the inverter facility (INV) and to the converter facility (W).

8. The electric drive system (1) as claimed in claim 1, that comprises a control facility (SE) configured to control the inverter facility (INV) and/or the converter facility (W).

9. The electric drive system (1) as claimed in claim 1, which comprises a cooling system (KS) for the electric machine and/or for the inverter facility (INV) and/or for the converter facility (W).

10. The electric drive system (1) as claimed in claim 9, wherein the inverter facility (INV) is arranged in an electronics housing (4) that is arranged directly on the electric machine (EM), and wherein the electronics housing (4) comprises the cooling system (KS).

11. The electric drive system (1) as claimed in claim 1, which comprises a communication facility (KE).

12. The electric drive system (1) as claimed in claim 1, which comprises an object detection apparatus (7) configured during the inductive charging procedure to detect a foreign object (FO) between the first inductance (L1) and a second inductance (L2) that is required for the inductive charging procedure.

13. The electric drive system (1) as claimed in claim 1, wherein the first inductance (L1) is arranged on a lower face (2) of the electric machine (EM).

14. A method for inductively charging an energy storage device (B) of an electrically operated vehicle (F1) having the steps:
S1) providing an electric drive system (1) as claimed in claim 1;
S2) positioning the electrically operated vehicle (F1) over a second inductance (L2) in such a manner that the first inductance (L1) is positioned in a magnetic field of the second inductance (L2); and
S3) inductively charging the energy storage device (B) by way of the first inductance (L1).

15. The method as claimed in claim 14, wherein in the method step S3 an object detection apparatus (7) detects a foreign object (FO) in the magnetic field between the first inductance (L1) and the second inductance (L2) and the inductive charging procedure is immediately terminated.
